(19) United States
(12) Patent Application Publication
(10) Pub. No.: US 2008/0270839 A1
(43) Pub. Date: Oct. 30, 2008

(54) Masked signal trap loop avoidance

(76) Inventors: JenChang Ho, San Jose, CA (US); Edward J. Sharpe, Los Gatos, CA (US); Lawrence D.K.B. Dwyer, South San Francisco, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,306

(22) Filed: Apr. 30, 2007

(51) Int. Cl. G06F 11/00

(52) U.S. Cl. 714/38

(57) ABSTRACT

An embodiment of the invention provides an apparatus and a method for avoidance of a masked signal trap loop. The apparatus and method perform acts including: terminating a process of an application and generating a core dump file, if parameters are set in an error detection engine and a signal is masked when a coding error is encountered in the application.

### TECHNICAL FIELD

Embodiments of the invention relate generally to avoidance of a masked signal trap loop.

### BACKGROUND

In a UNIX operating system, signals are mechanisms for delivery of events to an application context. As known to those skilled in the art, a signal may be a communication or message from one process (i.e., a running instance of a software program) to another process, a communication or message occurring within a process itself, or a message that is initiated from an event on an interrupt stack. An application context represents, at least, an application code and an address (virtual memory point). An application context may span both the application space (user space) and the kernel space. An application context may establish signal handlers to take actions for specific signals, so that an operation that is requested by the application code is performed. If a signal handler is established and the application context has invoked with a coding error, the operating system will transfer the application context stream to the signal handler so that the application signal handler can be invoked to handle the coding error in a pre-defined manner in the application. One example of a coding error is a dereferencing a NULL pointer which results in a run-time error in a software program.

Another feature of signals is that signals may also be masked, on a signal-by-signal basis, typically by use of a signal mask bitmap. The effect of masking is to hold the signal (and event associated with the signal), and no action is taken on the signal until the application context has unmasked the signal. The application handler for the signal is not invoked if the signal is masked. Signals may be masked by the application context itself, so that the masking operation is not interrupted by those signals. Signal masking and the signal handlers are typically part of the application context state.

A problem with previous systems is that if a signal is masked (or ignored) by an application context and the application also encounters an error event associated with the signal, then the application is not able to make forward progress on the intended program operation because the application context will not be able to launch the error handling routine for the signal. The original machine state is resumed and results in the same error event for the signal. This condition leads to an infinite trap-loop problem, where the application will repeat in sending the signal to the operating system and the operating system will respond with the same error event for each signal. When the infinite trap-loop problem occurs, the application will continue to consume CPU (central processor unit) resources while making no forward progress on the intended operation that the application is trying to perform.

A prior solution for the infinite trap-loop problem will require the user or administrator to actually notice that the application is making no forward progress on the intended operation, and to then invoke a debugger to determine the problem cause and/or manually terminate the application. In some implementations, an automatic application can monitor the forward progress of the application. The problem is that manual intervention is often required (in the absence of a monitor) and that significant CPU resources are consumed before the infinite trap-loop problem is detected.

Another problem with this prior solution is that application core dump files are not generated when the signal is masked. The core dump files are text files or other files that programmers can diagnose for purposes of debugging. Current mechanisms that terminate an application are not able to generate core dump files for signals that are masked or ignored because the error handling routine is not invoked fro the masked signal. Therefore, the problem(s) in an application can be diagnosed only by debugging online, which means that the application is not being used during the debugging step. Online debugging is often not practical in a production environment, where it is important to restart and run the application.

Therefore, the current technology is limited in its capabilities and suffers from at least the above constraints and deficiencies.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram of an apparatus (system) in accordance with an embodiment of the invention.

FIG. 2 is a flow diagram of a method in accordance with an embodiment of the invention.

FIG. 3 is a flow diagram that shows the trap loop problem that is solved by an embodiment of the invention.

### DETAILED DESCRIPTION OF PREFERRED EMBODIMENTS

In the description herein, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, methods, components, materials, parts, and/or the like. In other instances, well-known structures, materials, or operations are not shown or described in detail to avoid obscuring aspects of embodiments of the invention.

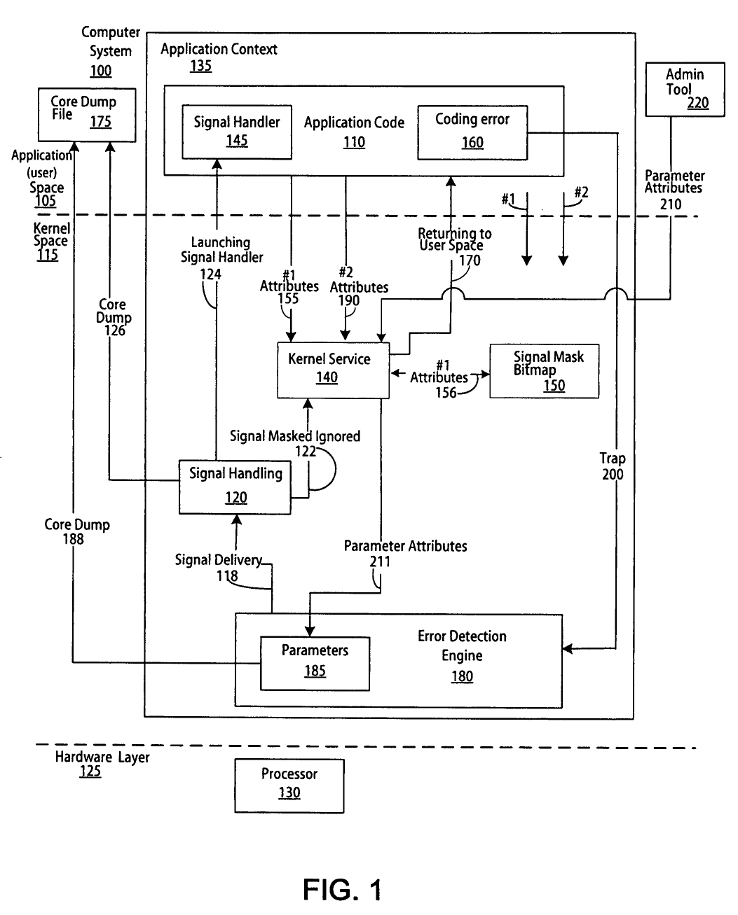

FIG. 1 is a block diagram of a system (apparatus) 100 in accordance with an embodiment of the invention. The system 100 is typically a computer system that is in a computing device. An application space (user space) 105 will have an application code 110 that will run in the system 100. It is understood that more than one application code can operate in the user space 105.

A kernel space 115 includes an operating system with signal handling routine 120 that will run in the system 100. Other elements will operate in the kernel space 115, as discussed below.

A hardware layer 125 includes a processor 130 that can execute various software codes (e.g., application code 110 and signal handling routine 120) in the system 100. The hardware layer 125 also includes other hardware elements that are typically used in a computing device.

An application context 135 represents, at least, an application code 110 and an address (virtual memory point). As known to those skilled in the art, an application context permits the operation of an application. The application context 135 may span both the application space (user space) 105 and the kernel space 115. The application context 135 may establish signal handlers to take actions for specific signals, so that an operation that is requested by the application code 110 is performed.

Signals are mechanisms for delivery of events to an application context 135. As known to those skilled in the art, a signal may be a communication or message from one process (i.e., a running instance of a software program) to another process, a communication or message occurring within a process itself, or a message that is initiated from an event on an interrupt stack.

The application code 110 makes a call to invoke a kernel service 140 in the application context 135 and in kernel space 115, so that the kernel service 140 can perform an operation on behalf of the application code 110. The application code 110 may, for example, need to access a file on a hard drive and may utilize an I/O file service that is performed by the kernel service 140, so that an I/O request by the application code 110 is serviced. The kernel 140 can invoke another kernel service (e.g., a remote kernel service) to perform an operation on behalf of the application code 110, as discussed in, for example, commonly-assigned U.S. patent application Ser. No. 11/031,120, by Edward J. Sharpe, James A. Woodward, Jenchang Ho, filed on Jan. 6, 2005, entitled “UNIX SIGNAL INTERRUPTION BEHAVIOR IN SERVER CONTEXTS”, which is hereby fully incorporated herein by reference.

The application code 110 will set attributes 155 and 190 for signals #1 and #2, respectively. These attributes are action codes which control the response of the operation system if and when the associated signal is posted to the application context 135 (which may affect the signal mask 150). The signals are posted by the operating system as a consequence of encountering a coding error (or execution error) 160. As known to those skilled in the art, common action codes that are used to perform an action on a signal include, for example, but are not limited to, a handler (stops a current operation by a kernel service so that a signal may be processed by launching a handler code), abort (stops a current operation by a kernel service), and ignore (i.e., does not disturb a current operation by a kernel service).

Assume that the signal #1 is masked. The signal #1 is typically masked by setting the attributes (values) 156 in a signal mask bitmap 150. Signal masking techniques are known to those skilled in the art. Examples of signal masking techniques by use of a signal mask bitmap are also described in, for example, commonly-assigned U.S. patent application Ser. No. 11/031,227, by Edward J. Sharpe, James A. Woodward, Jenchang Ho, filed on Jan. 6, 2005, entitled “SIGNAL MANAGEMENT IN OPERATIONS WITH MULTIPLE WAITS”, which is hereby fully incorporated herein by reference. In the example of FIG. 1, application context 135 will identify the signal #1 as a masked signal when the application context 135 checks the attributes 155 of the signal #1 and compares the attributes 155 with the signal mask bitmap 150. Note that in previous approaches, if the signal #1 is masked, then the signal handler 145 is not invoked for the signal #1. As a result, in previous approaches, if the application context 135 has invoked with coding errors 160 that are associated with the signal #1, the signal handling routine 120 is not able to launch a signal handler for handling the signal #1 because the signal #1 is masked. Since the signal handling routine 120 is not launched to handle the signal, the above-mentioned infinite trap-loop problem 170 would arise and will typically cause the application code 110 to not make forward progress while continuing to consume CPU resources.

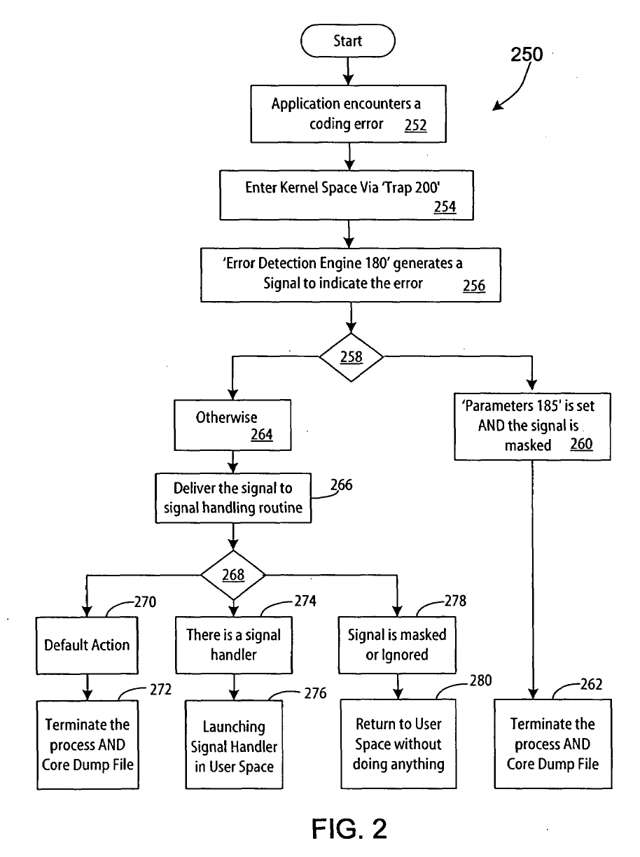

In accordance with an embodiment of the invention, a method is provided to detect that an application 110 has entered into a trap-loop problem 170, and to terminate the execution of the application. The signal handling routine 120 may also be invoked in order to generate a core dump file 175 (as shown in FIG. 2) for use in debugging of the coding error 160 that is associated with a masked signal. System parameters 185 may be set or controlled by the user or administrator, in order to permit the operations of the above features.

Assume that the application context 135 has previously set the attributes 155 for signal #1 such that the signal is masked in the signal mask bitmap 150. As the application 110 executes its instructions, it encounters a coding/execution error 160. This causes a signal #1 to be raised for application context 135. Since the signal #1 is masked (or is an ignored signal) and since the coding error 160 occurred, a detection engine 180 will terminate the process of the application code 110, rather than processing the signal #1 in the usual manner which can result in the above-mentioned trap-loop problem 170. Therefore, users or administrators will not have the burden to detect that the application 110 is not making forward progress. The detection engine 180 detects a masked signal by reading the bitmap 150 or by reading the attributes in the application context 135, and also detects the coding error 160 by reading the attributes in the application context 135.

When a coding error 160 occurs for a masked signal (e.g., signal #1), the detection engine 180 can also invoke the signal handling routine 120 which will then handle the coding error 160 in order to generate a core dump file 175. The user or administrator can diagnose the core dump file 175 for purposes of debugging the coding error 160. The core dump 175 may be, for example, a text file or another suitable file format. Methods for generating a core dump file for an application by use of error handling routines are known to those skilled in the art. The core dump file 175 can be generated for offline diagnosis of the coding error problem, and therefore allows the immediate restart of the affected application 110. Debugging of software programs by use of core dump files are known to those skilled in the art.

Note also that the above-described actions of the detection engine 180 are typically taken only for signals to be posted in a “synchronous” manner (i.e., signals that are initiated due to specific and erroneous instruction sequences of the application 110). The above-described actions are typically not taken for signals that are being posted by other processes or by interrupt handlers. The erroneous instruction sequences that are included in the coding errors 160 includes, for example, dereferencing through a NULL or invalid pointer, attempting to violate memory protections, attempting to execute an illegal instruction, floating point errors, divide by zero, and/or other coding errors that are well known to those skilled in the art.

Coding error occurrence is detected whether the targeted signal is masked or not masked. By masking off the targeted signal, the encountered error in the application can not be resolved and the application will not move forward due to the design of the operating system.

Because there is a remote possibility that some applications may depend upon the prior behavior of the application 110, customer-settable parameters 185 may be used to select and control the action to be taken in response to a trap-loop condition 170. The parameters 185 are typically data structure values that are variable and can control the functions that are performed by the detection engine 180. For example, the parameters 185 can be set to permit the detection engine 180 to terminate the application 110 and generate a core dump file 175, if coding errors 160 occur for masked signals. As another example, the parameters 185 can be set during the time that a user manually detects a trap-loop condition 170, in order to generate a core dump file 175.

The above-described steps that are performed on a masked signal by the detection engine 180 can also be applied to a signal #2 that is ignored based on the setting in the signal attributes 190. An ignored signal is a masked signal that is not unmasked.

FIG. 2 is a flow diagram of a method 250 in accordance with an embodiment of the invention. In block 252, an application 110 encounters a coding error 160. In block 254, a signal enters the kernel space 115 via trap path 200. In block 256, the error detection engine 180 generates a signal to indicate the coding error 160.

The method 250 can proceed from block 258. In block 260, the parameters 185 are noted as set and the signal has been masked by signal mask bitmap 150. An administrator tool 220 is used to input the parameter attributes 210 to the kernel service 140, and the kernel service 140 inputs the parameter attributes 211 for setting the parameters 185. The signal #1 attributes 156 are set to mask the signal #1.

In block 262, the process of the application 110 terminates and a core dump 188 will generate the core dump file 175.

If the method 250 proceeds from block 258 to block 264, then in block 266, the signal is delivered 118 to the signal handling routine 120.

From block 268, various paths may occur. From block 270 to block 272, the default action (setting) will terminate the process and the core dump 126 will generate the cored dump file 175.

From block 274 to block 276, a signal handler 145 is launched 124 in user space 105.

From block 278 to block 280, the signal is masked or ignored 122 and is returned 170 to user space.

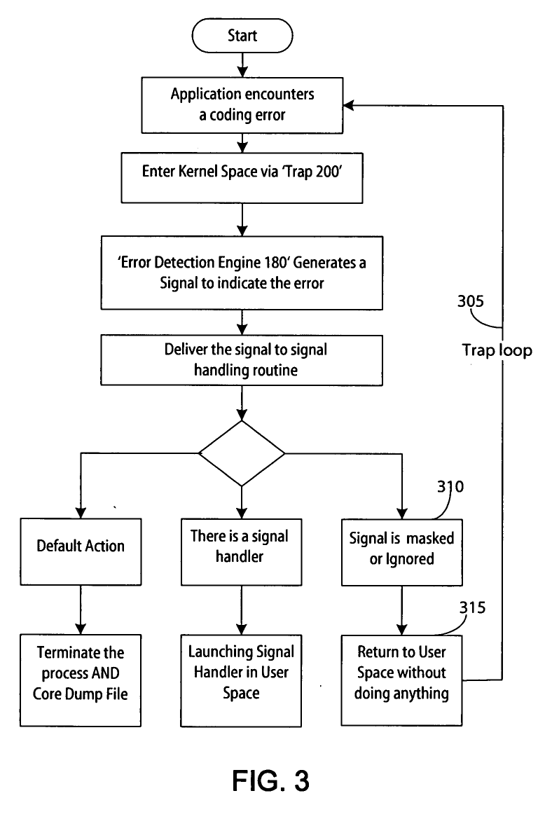

Note that FIG. 3 shows the trap loop 305 of previous methods when the signal is masked or ignored (block 310) and returned to user space (block 315).

It is also within the scope of the present invention to implement a program or code that can be stored in a machine-readable or computer-readable medium to permit a computer to perform any of the inventive techniques described above, or a program or code that can be stored in an article of manufacture that includes a computer readable medium on which computer-readable instructions for carrying out embodiments of the inventive techniques are stored. Other variations and modifications of the above-described embodiments and methods are possible in light of the teaching discussed herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A method for avoidance of a masked signal loop trap, the method comprising:
terminating a process of an application and generating a core dump file, if parameters are set in an error detection engine and a signal is masked when a coding error is encountered in the application.

2. The method of claim 1, further comprising:
debugging the coding error by diagnosis of the core dump file.

3. The method of claim 1, further comprising:
setting the parameters by use of an administrator tool.

4. The method of claim 3 wherein the parameters are set by parameter attributes.

5. The method of claim 1, wherein if the parameters are not set, then delivering the signal to a signal handling routine.

6. The method of claim 5, further comprising:
in a default setting, terminating the process and generating a core dump file.

7. The method of claim 5, further comprising:
launching a signal handler in user space.

8. The method of claim 5, further comprising:
returning the masked signal to user space.

9. An apparatus for avoidance of a masked signal loop trap, the apparatus comprising:
an operating system configured to terminate a process of an application and generate a core dump file, if parameters are set in an error detection engine and a signal is masked when a coding error is encountered in the application.

10. The apparatus of claim 9, wherein the coding error is debugged by diagnosis of the core dump file.

11. The apparatus of claim 9, wherein the parameters are set by use of an administrator tool.

12. The apparatus of claim 11 wherein the parameters are set by parameter attributes.

13. The apparatus of claim 9, wherein if the parameters are not set, then the signal is delivered to a signal handling routine.

14. The apparatus of claim 13, wherein in a default setting, the process terminates and a core dump file is generated.

15. The apparatus of claim 13, wherein a signal handler in user space is launched.

16. The apparatus of claim 13, wherein the masked signal is returned to user space.

17. An apparatus for avoidance of a masked signal loop trap, the apparatus comprising:
means for terminating a process of an application and means for generating a core dump file, if parameters are set in an error detection engine and a signal is masked when a coding error is encountered in the application.

18. An article of manufacture comprising:
a machine-readable medium having stored thereon instructions to:
terminate a process of an application and generate a core dump file, if parameters are set in an error detection engine and a signal is masked when a coding error is encountered in the application.
